(19) United States
(12) Patent Application Publication
(10) Pub. No.: US 2017/0099823 A1
(43) Pub. Date: Apr. 13, 2017

(54) Artificial Snake Fishing Lure

(71) Applicant: D.O.A. INC., Stuart, FL (US)

(72) Inventor: Mark S. Nichols, Stuart, FL (US)

(73) Assignee: D.O.A. INC., Stuart, FL (US)

(21) Appl. No.: 15/285,283

(22) Filed: Oct. 4, 2016

Related U.S. Application Data
(60) Provisional application No. 62/238,335, filed on Oct. 7, 2015.

(51) Int. Cl. A01K 85/16; B29C 33/42; A01K 85/00

(52) U.S. Cl. CPC A01K 85/16; A01K 85/005; B29C 33/42; B29L 2031/7002

(57) ABSTRACT

A method of forming a fishing lure resembling a snake such that the snake exhibits incredible lifelike action when pulled from a head of the lure through the water is disclosed. The method of forming the fishing lure may include forming the lure from a mold having at least one cavity forming a tube with a longitudinal axis curved in a spiral shape. When the lure is pulled from the mold after curing, the lure will extend generally along a linear longitudinal axis. However, because the snake lure was formed in a spiral shape, the lure has a much greater lifelike action than conventional artificial snakes that are formed with a linear cavity in a mold, such as within a mold having a linear, such as straight, longitudinal axis.

### CROSS-REFERENCE TO RELATED APPLICATION

This application claims the benefit of U.S. Provisional Patent Application No. 62/238,335, filed Oct. 7, 2015, the entirety of which is incorporated herein.

### FIELD OF THE INVENTION

This invention is directed generally to fishing lures, and more specifically to soft bodied fishing lures.

### BACKGROUND OF THE INVENTION

Artificial lures have been used for many years to catch fish in rivers, lakes, estuaries, bays, and oceans. Artificial lures typically are formed from either hard or soft materials. Some artificial lures are formed to resemble living snakes. When pulled through the water, the artificial snakes ride high in the water in a position that is at or on the surface of the water. Convention artificial snakes are produced in molds with linear longitudinal axes.

### SUMMARY OF THE INVENTION

A method of forming a fishing lure resembling a snake such that the snake exhibits incredible lifelike action when pulled from a head of the lure through the water is disclosed. The method of forming the fishing lure may include forming the lure from a mold having at least one cavity forming a tube with a longitudinal axis curved in a spiral shape. When the lure is pulled from the mold after curing, the lure will extend generally along a linear longitudinal axis. However, because the snake lure was formed in a spiral shape, the lure has a much greater lifelike action than conventional artificial snakes that are formed in a linear cavity in a mold, such as within a mold having a linear, such as straight, longitudinal axis.

In at least one embodiment, the method may of forming the fishing lure resembling a snake may include preparing a mold body for creating the fishing lure resembling a snake, whereby the mold body may include one or more cavities forming a tube with a longitudinal axis curved in a spiral shape. The method may also include filing the mold body with a flowable material that, when cured, forms a pliable material. The cavity may be an elongated cavity. In at least one embodiment, the cavity may have a ratio of length to widest cross-sectional dimension measured orthogonal to longitudinal axis of greater than 4:1.

The mold for forming a fishing lure resembling a snake may include one or more mold bodies having at least one cavity forming a tube with a longitudinal axis curved in a spiral shape, whereby the mold body is configured to receive a flowable material that, when cured, forms a pliable material. In at least one embodiment, the material used to form the fishing lure may be, but is not limited to, plastic, rubber, and other appropriate materials. In at least one embodiment, the material may be flexible.

In at least one embodiment, a fishing lure resembling a snake may be formed by the process of preparing a mold body for creating the fishing lure resembling a snake, whereby the mold body may include one or more cavities forming a tube with a longitudinal axi curved in a spiral shape. The process of forming the fishing lure resembling a snake may also include filing the mold body with a flowable material that, when cured, forms a pliable material.

An advantage of the fishing lure formed via a spiral shaped mold is that the lure has a much greater lifelike action than conventional artificial snakes that are formed with a linear cavity in a mold.

Another advantage of the fishing lure resembling a snake and formed via a spiral shaped mold is that the lure, when pulled either completely submerged or along a surface of the water, has an action with lifelike serpentine curves along the length of the body of the fishing lure, just like a living snake swimming in water. Such action enhances the likelihood of a predatory strike from a fish.

These and other embodiments will be described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a perspective view of an artificial snake fishing lure according to the invention.

FIG. 2 is a top view of the artificial snake fishing lure of FIG. 1.

FIG. 3 is a bottom view of the artificial snake fishing lure of FIG. 1.

FIG. 4 is a right side view of the artificial snake fishing lure of FIG. 1.

FIG. 5 is a left side view of the artificial snake fishing lure of FIG. 1.

FIG. 6 is a front view of the artificial snake fishing lure of FIG. 1.

FIG. 7 is a top view of the artificial snake fishing lure of FIG. 1 in a curled position.

FIG. 8 is a perspective view of another embodiment of the artificial snake fishing lure according to the invention.

FIG. 9 is a top view of the artificial snake fishing lure of FIG. 8.

FIG. 10 is a bottom view of the artificial snake fishing lure of FIG. 8.

FIG. 11 is a right side view of the artificial snake fishing lure of FIG. 8.

FIG. 12 is a left side view of the artificial snake fishing lure of FIG. 8.

FIG. 13 is a front view of the artificial snake fishing lure of FIG. 8.

FIG. 14 is a top view of the artificial snake fishing lure of FIG. 8 in a curled position.

FIG. 15 is a perspective view of a mold body configured to create the artificial snake fishing lure.

FIG. 16 is a perspective view of another embodiment of a mold body formed from first and second mold bodies configured to create the artificial snake fishing lure.

FIG. 17 is a flow diagram of a method of creating the artificial snake fishing lure.

### DETAILED DESCRIPTION OF PREFERRED EMBODIMENTS

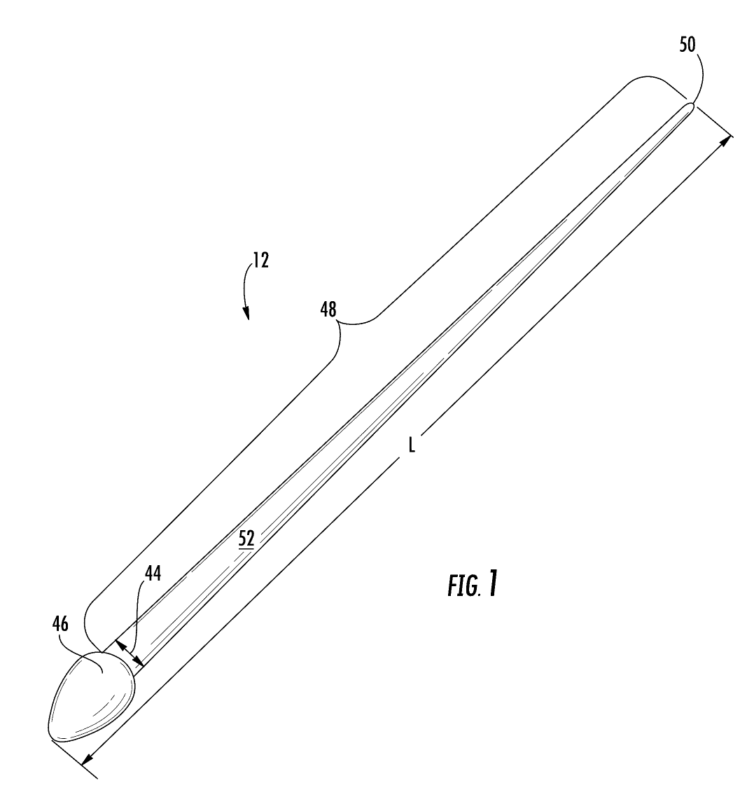

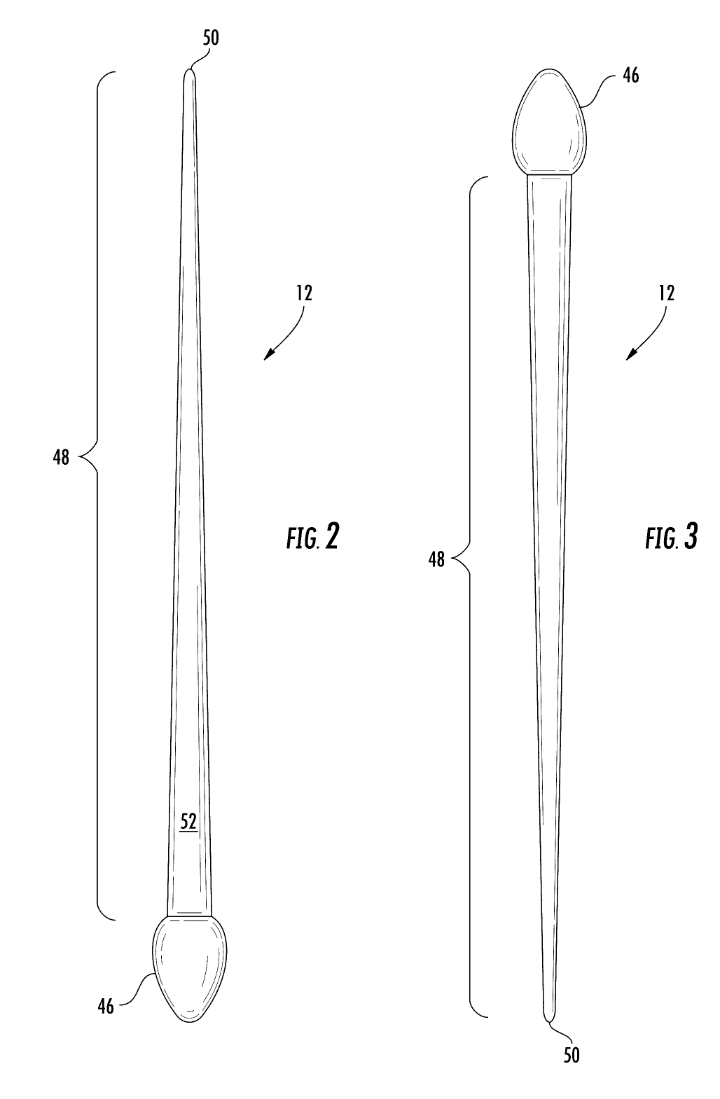

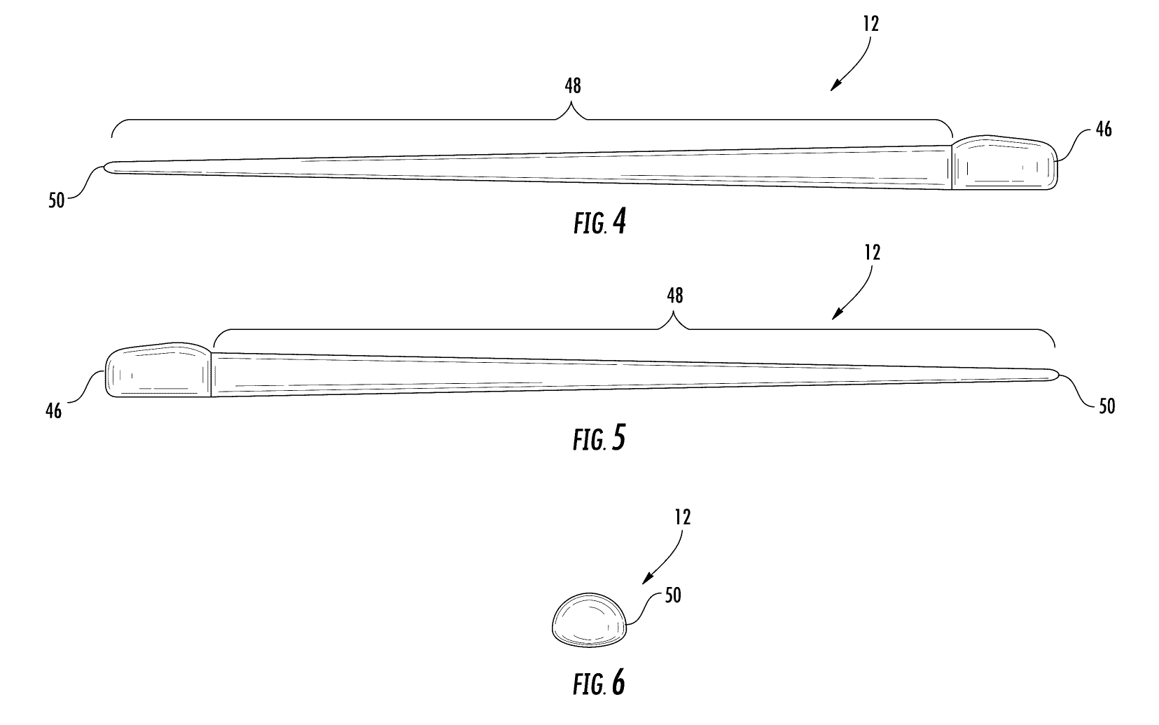

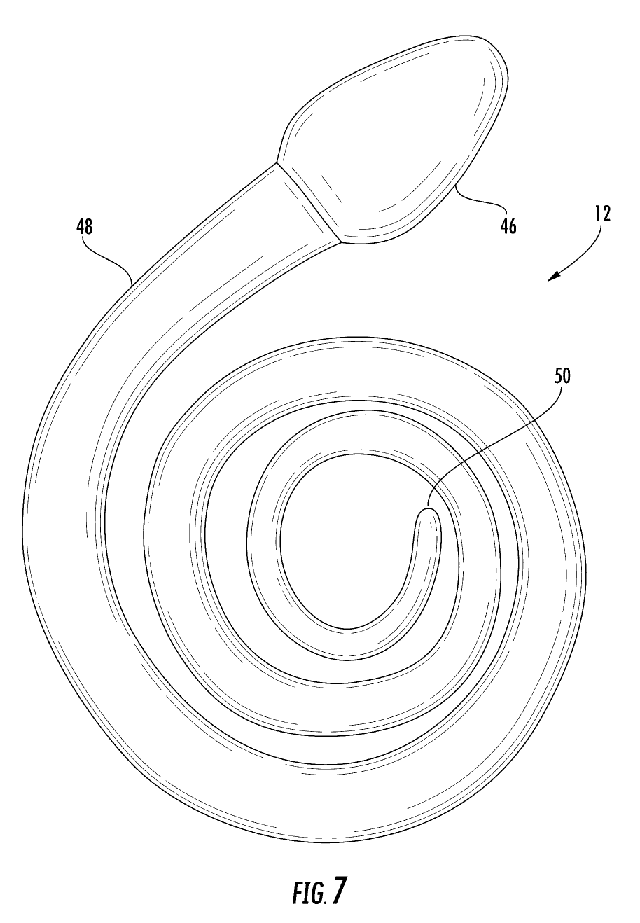

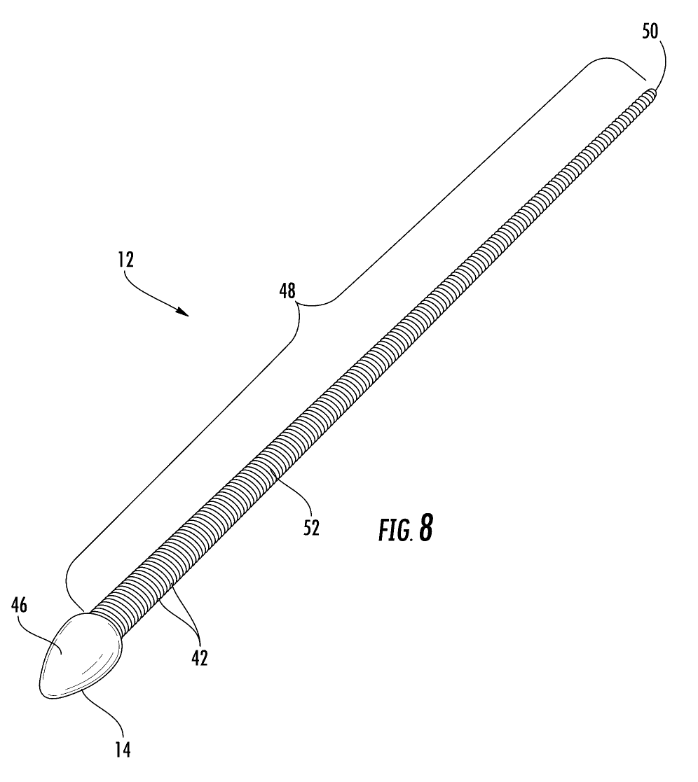

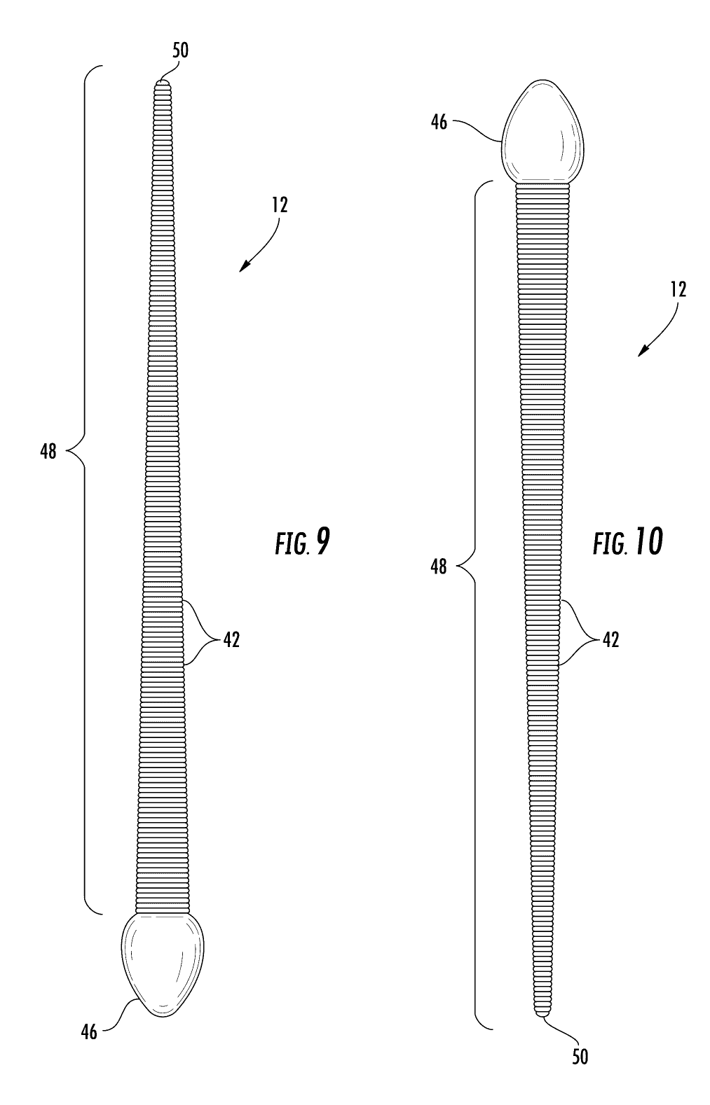

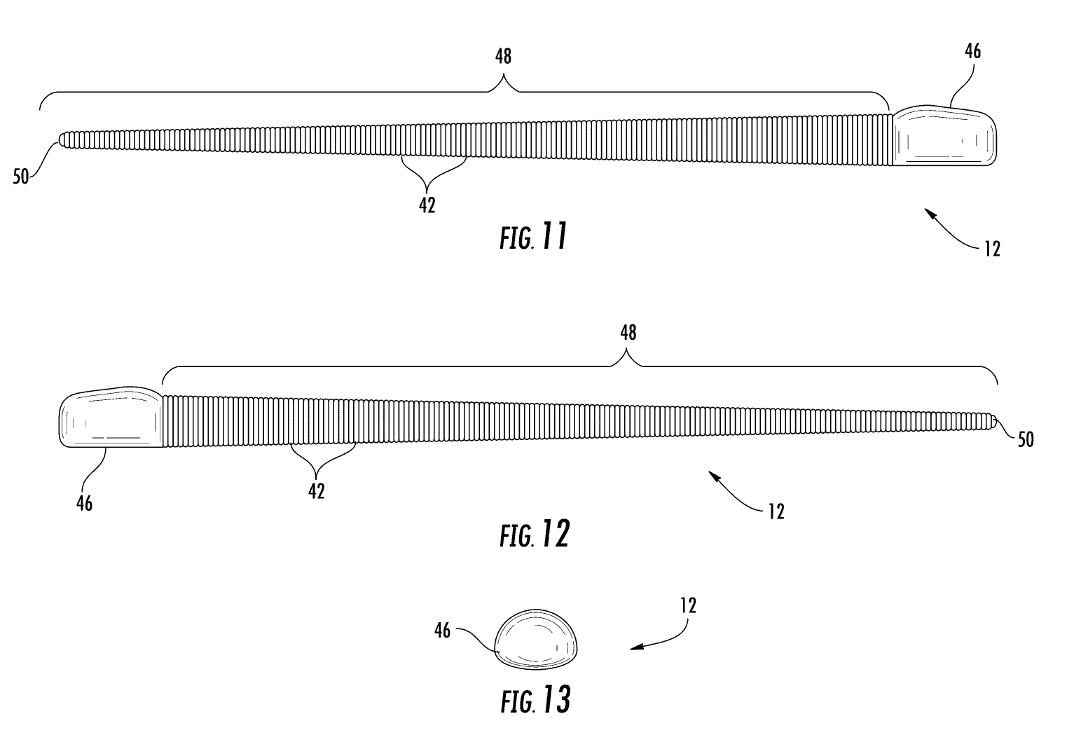

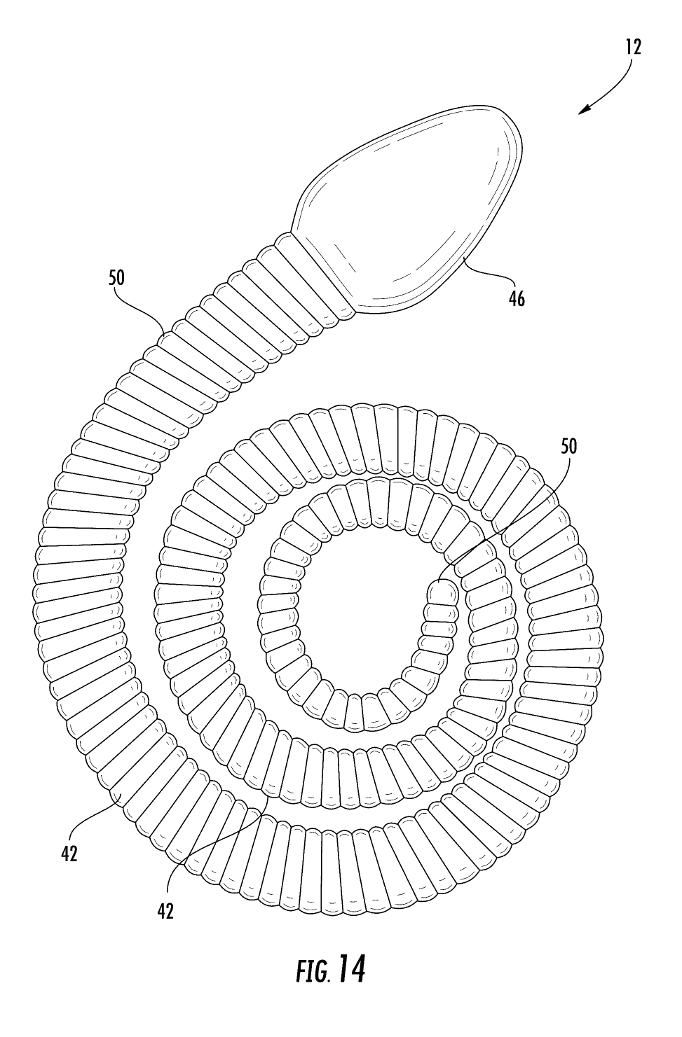

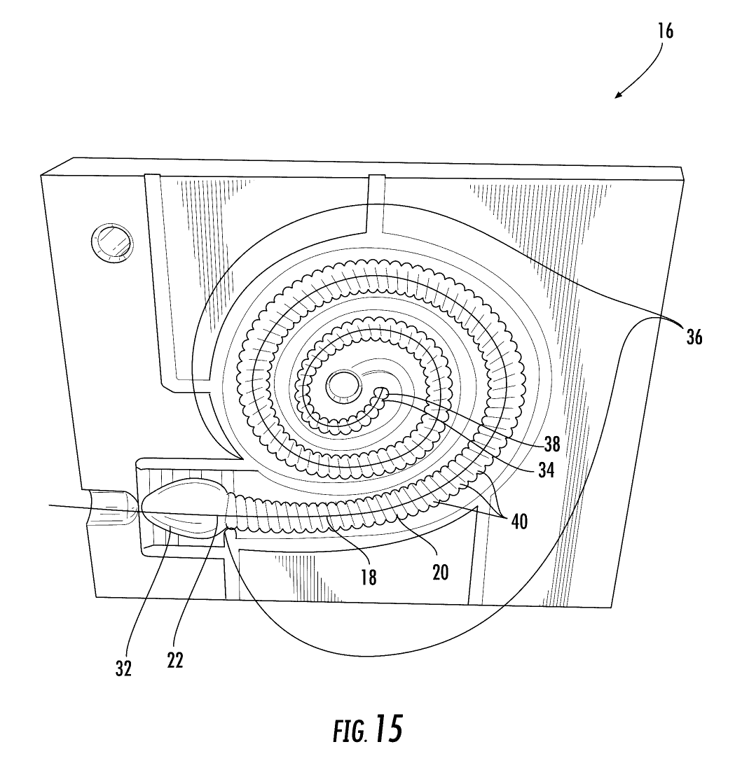

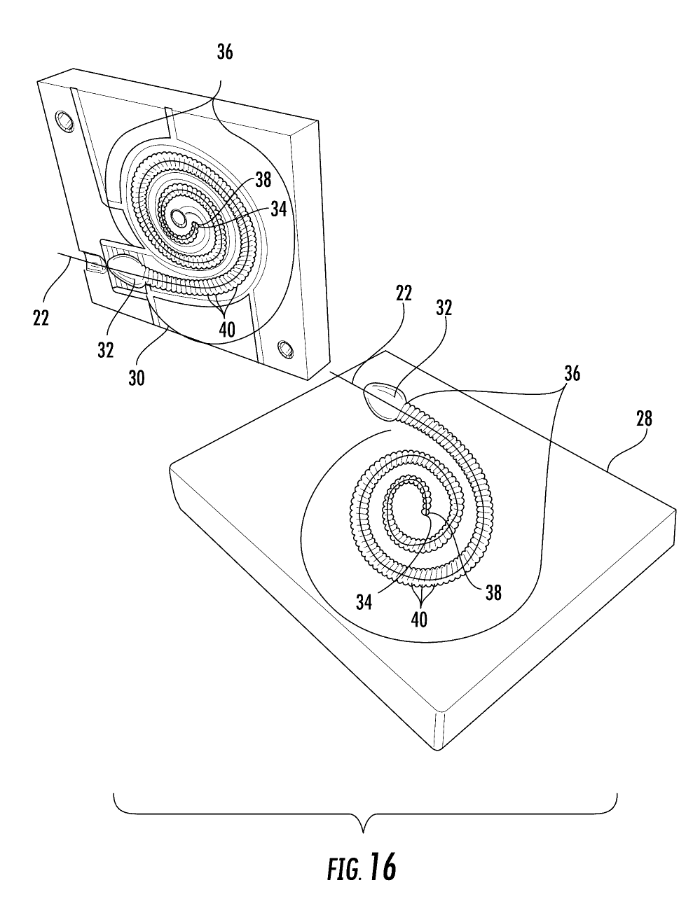

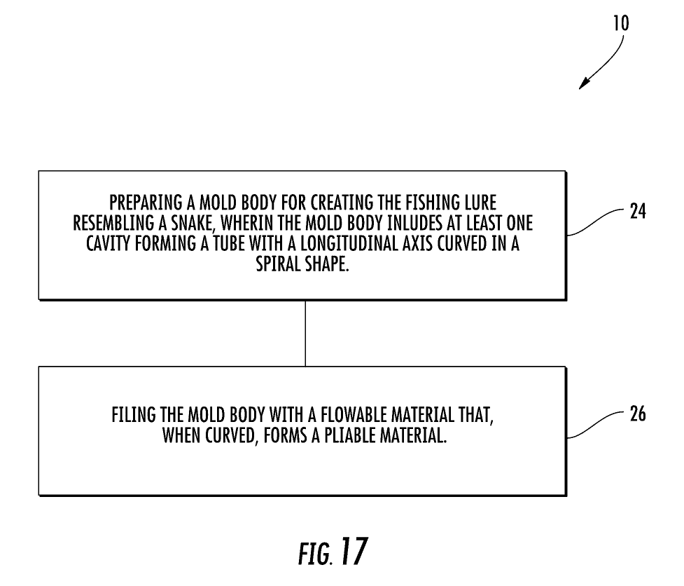

As shown in FIGS. 1-17, a method 10 of forming a fishing lure 12 resembling a snake such that the snake exhibits incredible lifelike action when pulled from a head 46 of the lure 12 through the water is disclosed. The method 10, as shown in FIG. 17, of forming the fishing lure 12 may include forming the lure 12 from a mold 16 having at least one cavity 18 forming a tube 20 with a longitudinal axis 22 curved in a spiral shape. When the lure 12 is pulled from the mold 16 after curing, the lure 12 will extend generally along a linear longitudinal axis 22. However, because the snake lure 12 was formed in a spiral shape, the lure 12 has a much greater lifelike action than conventional artificial snakes that are formed in a linear cavity in a mold, such as within a mold having a linear, such as straight, longitudinal axis.

In at least one embodiment, the method 10 may of forming the fishing lure 12 resembling a snake may include preparing a mold body 16 at 24 for creating the fishing lure 12 resembling a snake, whereby the mold body 16 may include one or more cavities 18 forming a tube 20 with a longitudinal axis 22 curved in a spiral shape. The method 10 may also include filing the mold body 16 at 26 with a flowable material that, when cured, forms a pliable material. The cavity 18 may be an elongated cavity. In at least one embodiment, the cavity 18 may have a ratio of length to widest cross-sectional dimension measured orthogonal to longitudinal axis 22 at 44 of greater than 4:1. In at least one embodiment, the cavity 18 may have a ratio of length to widest cross-sectional dimension measured orthogonal to longitudinal axis 22 at 44 of greater than 10:1. In at least one embodiment, the cavity 18 may have a ratio of length to widest cross-sectional dimension measured orthogonal to longitudinal axis 22 at 44 of greater than 20:1. In at least one embodiment, the cavity 18 may have a ratio of length to widest cross-sectional dimension measured orthogonal to longitudinal axis 22 at 44 between 4:1 and 50:1. In at least one embodiment, the cavity 18 may have a ratio of length to widest cross-sectional dimension measured orthogonal to longitudinal axis 22 at 44 between 15:1 and 30:1.

The step of preparing the mold body 16 at 24 for creating the fishing lure 12 resembling a snake may include preparing a mold body 16, wherein the mold body 16 is formed from at least two bodies forming a first mold body 28 and a second mold body 30, whereby at least a portion of the cavity 18 forming the tube 20 with the longitudinal axis 22 curved in a spiral shape is positioned within the first mold body 28. In at least one embodiment, the step of preparing the mold body 16 at 24 for creating the fishing lure 12 resembling a snake may include preparing a mold body 16, wherein the mold body 16 is formed from at least two bodies forming a first mold body 28 and a second mold body 30, whereby at least a portion of the cavity 18 forming the tube 20 with the longitudinal axis 22 curved in a spiral shape is positioned within the first mold body 28 and at least a portion of the cavity 18 forming the tube 20 with the longitudinal axis 22 curved in a spiral shape is positioned within the second mold body 30.

The step of preparing the mold body 16 at 24 for creating the fishing lure 12 resembling a snake may include preparing a mold body 16, wherein the cavity 18 forming the tube 20 with the longitudinal axis 22 curved in a spiral shape may include one or more head sections 32 having at least one cross-sectional area positioned orthogonal to the longitudinal axis 22 of the cavity 18 that is larger than cross-sectional areas of the remainder of the cavity 18 extending to a tail 34. In at least one embodiment, the step of preparing the mold body 16 at 24 for creating the fishing lure 12 resembling a snake may include preparing a mold body 16, wherein the cavity 18 forming the tube 20 with the longitudinal axis 22 curved in a spiral shape may include a body section 36 having a larger cross-sectional area in contact with the head section 32 than the remainder of the cavity 18 extending to a tail 34 at a distal end 38 of the cavity 18.

The step of preparing the mold body 16 at 24 for creating the fishing lure 12 resembling a snake may include preparing a mold body 16, wherein the cavity 18 forming the tube 20 with the longitudinal axis 22 curved in a spiral shape may include preparing a mold body 16, wherein the body 36 having a larger cross-sectional area in contact with the head section 32 tapers to the tail 34 at a distal end 38 of the cavity 18 such that a cross-sectional area of the body 36 reduces in size moving from the head section 32 to the tail 34. In at least one embodiment, the step of preparing the mold body 16 at 24 for creating the fishing lure 12 resembling a snake may include preparing a mold body 16, wherein the cavity 18 forming the tube 20 with the longitudinal axis 22 curved in a spiral shape may include preparing a mold body 16, wherein the body 36 includes a plurality of grooves 40 positioned next to each other from the head section 32 to the tail 34 which collectively form a plurality of concentric rings 42 about the body 36 of the fishing lure 12.

The mold 16 for forming a fishing lure 12 resembling a snake may include one or more mold bodies 16 having at least one cavity 18 forming a tube 20 with a longitudinal axis 22 curved in a spiral shape, whereby the mold body 16 is configured to receive a flowable material that, when cured, forms a pliable material. In at least one embodiment, the material used to form the fishing lure may be, but is not limited to, plastic, rubber, and other appropriate materials. In at least one embodiment, the material may be flexible.

In at least one embodiment, the mold body 16 may be formed from at least two bodies forming a first mold body 28 and a second mold body 30, whereby at least a portion of the cavity 18 forming the tube 20 with the longitudinal axis 22 curved in a spiral shape is positioned within the first mold body 28. In at least one embodiment, the mold body 16 may be formed from at least two bodies forming a first mold body 28 and a second mold body 30, whereby at least a portion of the cavity 18 forming the tube 20 with the longitudinal axis 22 curved in a spiral shape is positioned within the first mold body 28 and at least a portion of the cavity 18 forming the tube 20 with the longitudinal axis 22 curved in a spiral shape is positioned within the second mold body 30.

The mold 16 may be configured such that the cavity 18 forming the tube 20 with the longitudinal axis 22 curved in a spiral shape may include one or more head sections 32 having at least one cross-sectional area positioned orthogonal to the longitudinal axis 22 of the cavity 18 that is larger than cross-sectional areas of the remainder of the cavity 18. In at least one embodiment, the mold 16 having the cavity 18 forming a tube 20 with a longitudinal axis 22 curved in a spiral shape may include a body section 36 having a larger cross-sectional area in contact with the head section 32 than the remainder of the cavity 18 extending to a tail 34 at a distal end of the cavity 18.

The mold 16 may be configured such that the cavity 18 forming the tube 20 with the longitudinal axis 22 curved in a spiral shape may include the body 36 having a larger cross-sectional area in contact with the head section 32 tapering to the tail 34 at a distal end 38 of the cavity 18 such that a cross-sectional area of the body 36 reduces in size moving from the head section 32 to the tail 34. In at least one embodiment, the mold 16 having the cavity 18 forming a tube 20 with a longitudinal axis 22 curved in a spiral shape may include within the body 36 a plurality of grooves 40 positioned next to each other from the head section 32 to the tail 34 which collectively form a plurality of concentric rings 42 about the body 36 of the fishing lure.

In at least one embodiment, a fishing lure 12 resembling a snake may be formed by the process of preparing a mold body 16 at 24 for creating the fishing lure 12 resembling a snake, whereby the mold body 16 may include one or more cavities 18 forming a tube 20 with a longitudinal axis 22 curved in a spiral shape. The process of forming the fishing lure 12 resembling a snake may also include filing the mold body 16 at 26 with a flowable material that, when cured, forms a pliable material. The process of preparing the mold body 16 at 24 for creating the fishing lure resembling a snake may include preparing a mold body 16 for creating the fishing lure 12 resembling a snake, whereby the mold body is formed from at least two bodies forming a first mold body 28 and a second mold body 30, whereby at least a portion of the cavity 18 forming the tube 20 with the longitudinal axis 22 curved in a spiral shape is positioned within the first mold body 28. In at least one embodiment, the process of preparing the mold body 16 at 24 for creating the fishing lure resembling a snake may include preparing a mold body 16 for creating the fishing lure 12 resembling a snake, whereby the mold body is formed from at least two bodies forming a first mold body 28 and a second mold body 30, whereby at least a portion of the cavity 18 forming the tube 20 with the longitudinal axis 22 curved in a spiral shape is positioned within the first mold body 28 and at least a portion of the cavity 18 forming the tube 20 with the longitudinal axis 22 curved in a spiral shape is positioned within the second mold body 30.

In at least one embodiment, the process of preparing the mold body 16 at 24 for creating the fishing lure resembling a snake may include preparing a mold body 16 for creating the fishing lure 12 resembling a snake, whereby the cavity 18 forming the tube 20 with the longitudinal axis 22 curved in a spiral shape may include at least one head section 32 having at least one cross-sectional area positioned orthogonal to the longitudinal axis 22 of the cavity 18 that is larger than cross-sectional areas of the remainder of the cavity 18. The process of preparing the mold body 16 at 24 for creating the fishing lure resembling a snake may include preparing a mold body 16 for creating the fishing lure 12 resembling a snake, whereby the cavity 18 forming the tube 20 with the longitudinal axis 22 curved in a spiral shape may include a body section 36 having a larger cross-sectional area in contact with the head section 32 than the remainder of the cavity 18 extending to a tail 34 at a distal end 38 of the cavity 18. In at least one embodiment, the process of preparing the mold body 16 at 24 for creating the fishing lure resembling a snake may include preparing a mold body 16 for creating the fishing lure 12 resembling a snake, whereby the body 36 having a larger cross-sectional area in contact with the head section 32 tapers to the tail 34 at a distal end 38 of the cavity 18 such that a cross-sectional area of the body 36 reduces in size moving from the head section 32 to the tail 34.

The process of forming the lure 12 may results in a lure resembling a snake having a head 46, as shown in FIGS. 1-14, and a main body section 48 extending from a proximal end of the head 46. The main body section 48 may have a smaller cross-sectional area, and in at least one embodiment, a smaller diameter, than a largest cross-sectional area of the head 46. The main body section 48 may have a larger cross-sectional area, and in at least one embodiment, a larger diameter, at the intersection with the head 46 than at other points along the body section 48 extending to the tail 50. In at least one embodiment, the main body section 48 may taper in size from a largest cross-sectional area at the intersection with the head 46 to a smallest cross-sectional area at the tail 50. The outer surface 52 of the main body section 48 may include one or more concentric rings 42.

It should be understood that the examples and embodiments described herein are for illustrative purposes only and that various modifications or changes in light thereof will be obvious to persons skilled in the art, and that such modifications or changes are to be included within the spirit and purview of this application. Moreover, the invention can take other specific forms without departing from the spirit or essential attributes thereof.

I claim:

1. A method of forming a fishing lure resembling a snake, comprising:
preparing a mold body for creating the fishing lure resembling a snake, wherein the mold body includes at least one cavity forming a tube with a longitudinal axis curved in a spiral shape;
filing the mold body with a flowable material that, when cured, forms a pliable material.

2. The method of forming a fishing lure resembling a snake of claim 1, wherein preparing a mold body for creating the fishing lure resembling a snake comprises preparing a mold body for creating the fishing lure resembling a snake, wherein the mold body is formed from at least two bodies forming a first mold body and a second mold body, wherein at least a portion of the at least one cavity forming the tube with the longitudinal axis curved in a spiral shape is positioned within the first mold body.

3. The method of forming a fishing lure resembling a snake of claim 1, wherein preparing a mold body for creating the fishing lure resembling a snake comprises preparing a mold body for creating the fishing lure resembling a snake, wherein the mold body is formed from at least two bodies forming a first mold body and a second mold body, wherein at least a portion of the at least one cavity forming the tube with the longitudinal axis curved in a spiral shape is positioned within the first mold body and at least a portion of the at least one cavity forming the tube with the longitudinal axis curved in a spiral shape is positioned within the second mold body.

4. The method of forming a fishing lure resembling a snake of claim 1, wherein preparing a mold body for creating the fishing lure resembling a snake, wherein the mold body includes at least one cavity forming a tube with a longitudinal axis curved in a spiral shape comprises preparing a mold body for creating the fishing lure resembling a snake, wherein the at least one cavity forming the tube with the longitudinal axis curved in a spiral shape includes at least one head section having at least one cross-sectional area positioned orthogonal to the longitudinal axis of at least one cavity that is larger than cross-sectional areas of the remainder of the at least one cavity.

5. The method of forming a fishing lure resembling a snake of claim 4, wherein preparing a mold body for creating the fishing lure resembling a snake, wherein the mold body includes at least one cavity forming a tube with a longitudinal axis curved in a spiral shape comprises preparing a mold body for creating the fishing lure resembling a snake, wherein the at least one cavity forming a tube with a longitudinal axis curved in a spiral shape includes a body section having a larger cross-sectional area in contact with the at least one head section than the remainder of the at least one cavity extending to a tail at a distal end of the at least one cavity.

6. The method of forming a fishing lure resembling a snake of claim 5, wherein preparing a mold body for creating the fishing lure resembling a snake, wherein the mold body includes at least one cavity forming a tube with a longitudinal axis curved in a spiral shape comprises preparing a mold body for creating the fishing lure resembling a snake, wherein the body having a larger cross-sectional area in contact with the at least one head section tapers to the tail at a distal end of the at least one cavity such that a cross-sectional area of the body reduces in size moving from the at least one head section to the tail.

7. The method of forming a fishing lure resembling a snake of claim 5, wherein preparing a mold body for creating the fishing lure resembling a snake, wherein the mold body includes at least one cavity forming a tube with a longitudinal axis curved in a spiral shape comprises preparing a mold body for creating the fishing lure resembling a snake, wherein the body includes a plurality of grooves positioned next to each other from the head section to the tail which collectively form a plurality of concentric rings about the body of the fishing lure.

8. A mold for forming a fishing lure resembling a snake, comprising:
at least one mold body having at least one cavity forming a tube with a longitudinal axis curved in a spiral shape, wherein the at least one mold body is configured to receive a flowable material that, when cured, forms a pliable material.

9. The mold for forming a fishing lure resembling a snake of claim 8, wherein the at least one mold body is formed from at least two bodies forming a first mold body and a second mold body, wherein at least a portion of the at least one cavity forming the tube with the longitudinal axis curved in a spiral shape is positioned within the first mold body.

10. The mold for forming a fishing lure resembling a snake of claim 8, wherein the mold body is formed from at least two bodies forming a first mold body and a second mold body, wherein at least a portion of the at least one cavity forming the tube with the longitudinal axis curved in a spiral shape is positioned within the first mold body and at least a portion of the at least one cavity forming the tube with the longitudinal axis curved in a spiral shape is positioned within the second mold body.

11. The mold for forming a fishing lure resembling a snake of claim 8, wherein the at least one cavity forming the tube with the longitudinal axis curved in a spiral shape includes at least one head section having at least one cross-sectional area positioned orthogonal to the longitudinal axis of at least one cavity that is larger than cross-sectional areas of the remainder of the at least one cavity.

12. The mold for forming a fishing lure resembling a snake of claim 11, wherein the at least one cavity forming a tube with a longitudinal axis curved in a spiral shape includes a body section having a larger cross-sectional area in contact with the at least one head section than the remainder of the at least one cavity extending to a tail at a distal end of the at least one cavity.

13. The mold for forming a fishing lure resembling a snake of claim 12, wherein the body having a larger cross-sectional area in contact with the at least one head section tapers to the tail at a distal end of the at least one cavity such that a cross-sectional area of the body reduces in size moving from the at least one head section to the tail.

14. The mold for forming a fishing lure resembling a snake of claim 12, wherein the body includes a plurality of grooves positioned next to each other from the head section to the tail which collectively form a plurality of concentric rings about the body of the fishing lure.

15. A fishing lure resembling a snake formed by the process, comprising:
preparing a mold body for creating the fishing lure resembling a snake, wherein the mold body includes at least one cavity forming a tube with a longitudinal axis curved in a spiral shape;
filing the mold body with a flowable material that, when cured, forms a pliable material.

16. A fishing lure resembling a snake formed by the process of claim 15, wherein preparing a mold body for creating the fishing lure resembling a snake comprises preparing a mold body for creating the fishing lure resembling a snake, wherein the mold body is formed from at least two bodies forming a first mold body and a second mold body, wherein at least a portion of the at least one cavity forming the tube with the longitudinal axis curved in a spiral shape is positioned within the first mold body.

17. A fishing lure resembling a snake formed by the process of claim 15, wherein preparing a mold body for creating the fishing lure resembling a snake comprises preparing a mold body for creating the fishing lure resembling a snake, wherein the mold body is formed from at least two bodies forming a first mold body and a second mold body, wherein at least a portion of the at least one cavity forming the tube with the longitudinal axis curved in a spiral shape is positioned within the first mold body and at least a portion of the at least one cavity forming the tube with the longitudinal axis curved in a spiral shape is positioned within the second mold body.

18. A fishing lure resembling a snake formed by the process of claim 15, wherein preparing a mold body for creating the fishing lure resembling a snake, wherein the mold body includes at least one cavity forming a tube with a longitudinal axis curved in a spiral shape comprises preparing a mold body for creating the fishing lure resembling a snake, wherein the at least one cavity forming the tube with the longitudinal axis curved in a spiral shape includes at least one head section having at least one cross-sectional area positioned orthogonal to the longitudinal axis of at least one cavity that is larger than cross-sectional areas of the remainder of the at least one cavity.

19. A fishing lure resembling a snake formed by the process of claim 18, wherein preparing a mold body for creating the fishing lure resembling a snake, wherein the mold body includes at least one cavity forming a tube with a longitudinal axis curved in a spiral shape comprises preparing a mold body for creating the fishing lure resembling a snake, wherein the at least one cavity forming a tube with a longitudinal axis curved in a spiral shape includes a body section having a larger cross-sectional area in contact with the at least one head section than the remainder of the at least one cavity extending to a tail at a distal end of the at least one cavity.

20. A fishing lure resembling a snake formed by the process of claim 19, wherein preparing a mold body for creating the fishing lure resembling a snake, wherein the mold body includes at least one cavity forming a tube with a longitudinal axis curved in a spiral shape comprises preparing a mold body for creating the fishing lure resembling a snake, wherein the body having a larger cross-sectional area in contact with the at least one head section tapers to the tail at a distal end of the at least one cavity such that a cross-sectional area of the body reduces in size moving from the at least one head section to the tail.
